(19) United States
(12) Patent Application Publication
(10) Pub. No.: US 2020/0276070 A1
(43) Pub. Date: Sep. 3, 2020

(54) CASKET KEEPSAKE ORNAMENT AND ATTACHMENT MECHANISM

(71) Applicant: Batesville Services, Inc., Batesville, IN (US)

(72) Inventors: Kristine Ann Reynolds, Oldenburg, IN (US); Todd Jefferey Tekulve, Batesville, IN (US); Christopher M. Wessel, Metamora, IN (US); Gregory Wray, Guilford, IN (US)

(21) Appl. No.: 16/803,160

(22) Filed: Feb. 27, 2020

Related U.S. Application Data
(60) Provisional application No. 62/811,744, filed on Feb. 28, 2019.

(51) Int. Cl. A61G 17/04; A47G 1/06; A47G 1/14

(52) U.S. Cl. CPC A61G 17/042; A61G 17/0407; A47G 2001/0694; A47G 1/142; A47G 2001/0672; A47G 1/06

(57) ABSTRACT

A keepsake comprises a picture frame, a pair of vertically spaced posts on a rear side of the picture frame, each post having a head thereon, a pair vertically spaced threaded holes on the rear side of the picture frame, each of the threaded holes adapted to receive a screw to secure a magnet to the rear side of the picture frame, a cradle on the rear side of the picture frame, and a kickstand removably secured in the cradle, the kickstand having a threaded end that threads into a lowermost one of the threaded holes. The picture frame is securable to a casket shell corner having a pair of vertically spaced keyhole grooves or to a ferrous metallic cap panel of a casket lid, and is displayable on a horizontal surface via the kickstand.

### RELATED APPLICATIONS

This application claims the priority benefit of U.S. Provisional Patent Application No. 62/811,744 filed Feb. 28, 2019, which is hereby incorporated by reference herein as if fully set forth in its entirety.

### FIELD OF THE INVENTION

This invention relates generally to caskets, and more particularly to mechanisms for attaching ornaments to caskets.

### BACKGROUND OF THE INVENTION

It is known to attach decorative ornaments to caskets to “personalize” the casket to the deceased. Over the years various mechanisms have been devised by the assignee to attach decorative ornaments to funerary articles, and more particularly, to attach decorative corner ornaments to casket corners.

Examples of mechanisms for attaching decorative “figurine” style ornaments to the exterior of a casket, for example to the corners of the casket shell, are shown in, for example, the assignee's U.S. Pat. Nos. 6,591,466, 6,928,706, 7,340,810 and 7,591,052, and US Patent Application Publication No. 2010/0077579, all hereby incorporated by reference herein as if fully set forth in their entireties. The ornaments of the '466, '706, and '810 patents, and the '579 publication, utilize fasteners with heads, for example shoulder screws, mounted on the flat or planar rear side of the ornament, the heads of which are secured in keyhole slots or grooves, for example L-shaped keyhole slots or grooves, in the casket shell corners.

Examples of mechanisms for attaching decorative “medallion” style ornaments to the interior of the casket, for example to the cap panel, and to the exterior of the casket, for example to the corners of the casket shell, are shown in, for example, the assignee's U.S. Pat. Nos. 8,220,119, 8,387,219, 8,555,471, 8,567,023, 8,756,774, and 9,132,054, all hereby incorporated by reference herein as if fully set forth in their entireties. The ornaments of the '119, '219, and '471, '023, '774, and '054 patents utilize magnets mounted on the rear side of the ornament which are secured to a magnetic cap panel and a magnetic adapter mounted to the casket shell corners.

All of these ornaments are commercially available from the assignee as its LIFESYMBOLS® line of casket shell corner ornaments.

Nevertheless, there remains room for improvement in such casket ornaments and casket ornament attachment mechanisms.

### SUMMARY OF THE INVENTION

In one aspect, a keepsake comprises a picture frame, a pair of vertically spaced posts on a rear side of the picture frame, each post having a head thereon, a pair vertically spaced threaded holes on the rear side of the picture frame, each of the threaded holes adapted to receive a screw to secure a magnet to the rear side of the picture frame, a cradle on the rear side of the picture frame, and a kickstand removably secured in the cradle, the kickstand having a threaded end that threads into a lowermost one of the threaded holes. The picture frame is thereby adapted to be secured to a casket shell corner having a pair of vertically spaced keyhole grooves that cooperate with the vertically spaced posts with said heads thereon, is adapted to be secured to a ferrous metallic cap panel of a casket lid which cooperates with the magnets, and is adapted to be displayed on a horizontal surface once the kickstand is threaded into the lowermost one of said threaded holes.

In another aspect, a casket comprises a casket shell having four corners, each corner having a pair of vertically spaced keyhole grooves therein, a casket lid closeable on the casket shell, the casket lid having a ferrous metallic cap panel installed therein, and a keepsake. The keepsake comprises a picture frame, a pair of vertically spaced posts on a rear side of the picture frame, each post having a head thereon, a pair vertically spaced threaded holes on the rear side of the picture frame, a pair of magnets, and a pair of screws. Each of the threaded holes is adapted to receive one of the screws to secure one of the magnets to the rear side of the picture frame. A cradle is located on the rear side of the picture frame. A kickstand is removably secured in the cradle. The kickstand has a threaded end that threads into a lowermost one of the threaded holes. The picture frame is selectably 1) securable to the casket shell corner via the pair of vertically spaced posts with heads thereon cooperating with the vertically spaced keyhole grooves, 2) securable to the casket lid ferrous metallic cap panel via the magnets cooperating with the ferrous metallic cap panel, and 3) displayable on a horizontal surface once the kickstand is threaded into the lowermost one of the threaded holes.

In another aspect, a keepsake comprises a picture frame, a pair of vertically spaced posts on a rear side of the picture frame, each post having a head thereon, a pair vertically spaced threaded holes on the rear side of the picture frame, a pair of magnets, and a pair of screws. Each of the threaded holes is adapted to receive one of the screws to secure one of the magnets to the rear side of the picture frame. A cradle is located on the rear side of the picture frame. A kickstand is removably secured in the cradle. The kickstand has a threaded end that threads into a lowermost one of the threaded holes. The picture frame is selectably 1) securable to a casket shell corner, an urn, or a display plaque having a pair of vertically spaced keyhole grooves via the pair of vertically spaced posts with heads, 2) securable to a casket lid, an urn, or a display plaque having a ferrous metallic sheet via the magnets cooperating with the sheet, and 3) displayable on a horizontal surface once the kickstand is threaded into the lowermost one of the threaded holes.

The accompanying drawings, which are incorporated in and constitute a part of this specification, illustrate embodiments of the invention and, together with the summary of the invention given above, and the detailed description of the drawings given below, serve to explain the principles of the present invention.

### BRIEF DESCRIPTION OF THE DRAWINGS

FIG. 1 is a front perspective view of the keepsake ornament according to the principles of the present invention.

FIG. 2 is a rear perspective view of the keepsake ornament of FIG. 1.

FIG. 3 is a cross-sectional view taken along line 3-3 in FIG. 2.

FIG. 4 is a rear exploded perspective view of the keepsake ornament of FIG. 1.

FIG. 5 is a perspective view of a casket with the keepsake ornament mounted to the casket lid cap panel.

FIGS. 5A and 5B are perspective views of a corner of a casket with the keepsake ornament being mounted to the casket shell corner.

FIG. 6 is a rear perspective view of the keepsake ornament displayed on a horizontal surface.

FIG. 7 is a front perspective view of the keepsake ornament being mounted to a cremation urn.

### DETAILED DESCRIPTION OF THE DRAWINGS

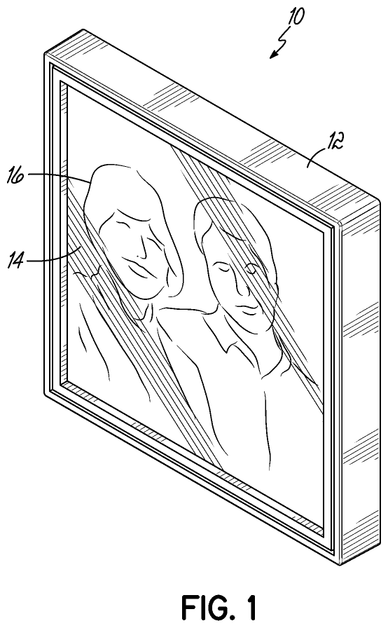

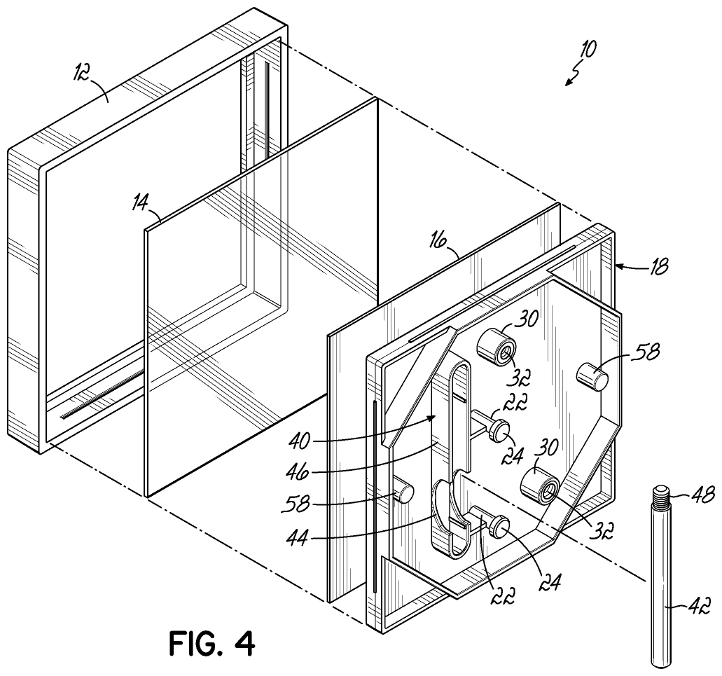

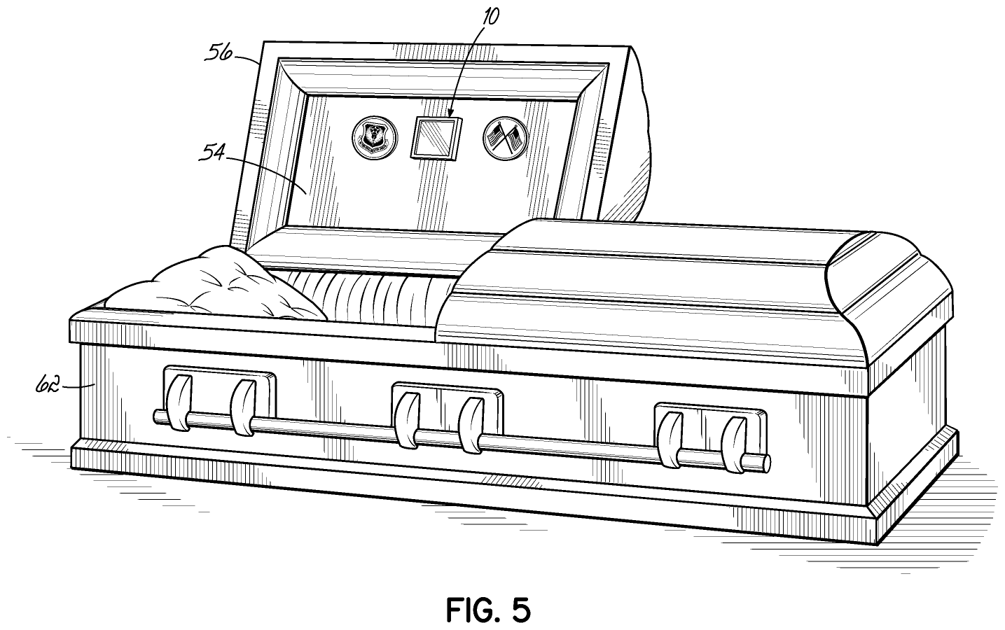

Referring first to FIGS. 1-4, there is illustrated a keepsake ornament 10 according to the principles of the present invention. The ornament 10 includes several means for mounting the ornament 10 to a casket, a cremation urn, and a display plaque, and for displaying the ornament 10 on a horizontal surface.

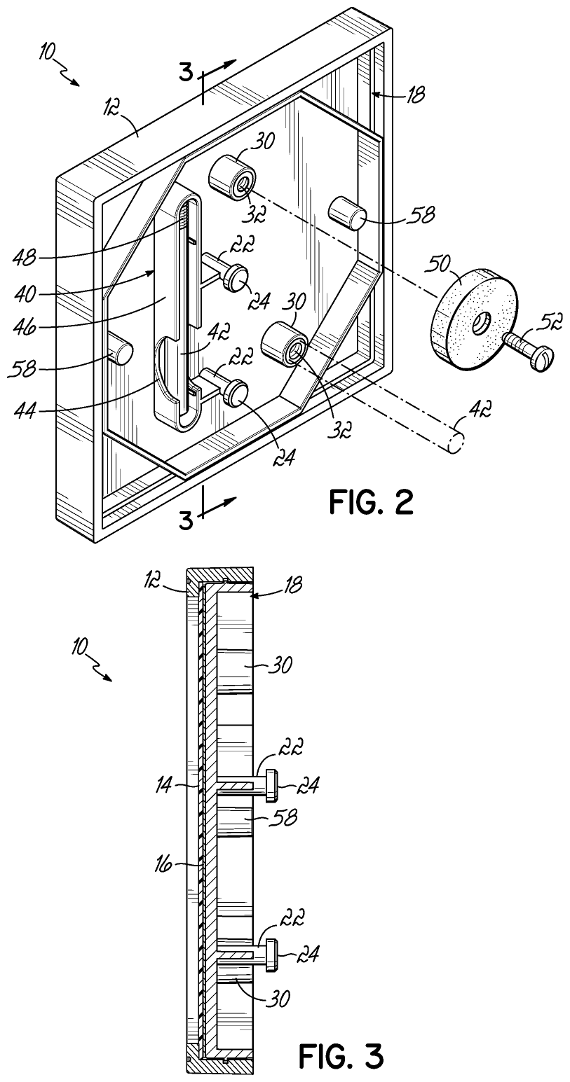

Referring to FIGS. 2-4, the ornament 10 includes a frame 12 (i.e. picture frame) and a transparent pane 14 (could be either glass or plastic) for displaying a photographic image or picture 16. A back plate 18 secures the picture 16 and pane 14 to the frame 12. The back plate 18 can be secured to the frame 12 by various means, for example the back plate 18 can be press-fitted into the frame 12.

The back plate 18 includes a pair of vertically spaced posts 22 on a rear side thereof. Each post 22 includes a head 24 thereon. The posts 22 are utilized to mount the ornament 10 to a casket shell corner, cremation urn, or display plaque, to be described below.

The back plate 18 further includes a second pair of vertically spaced posts 30 on a rear side thereof. Each post 30 includes a threaded hole 32 therein. The posts 30 are utilized to mount the ornament 10 to a casket lid cap panel and/or to display the ornament 10 on a horizontal surface, to be described below.

The back plate 18 further includes an elongated cradle 40 on a rear side thereof that houses a removable kick stand 42. The kick stand 42 is press-fitted into the cradle 40. The cradle 40 includes scalloped cut-outs 44 on either lateral side 46 thereof to assist a user in grasping the kick stand 42 between the thumb and fore finger to insert and remove the kick stand 42 into and from the cradle 40. The kick stand 42 includes a threaded end 48 which can be threaded into either of the posts 30 to display the ornament 10 on a horizontal surface, to be described below.

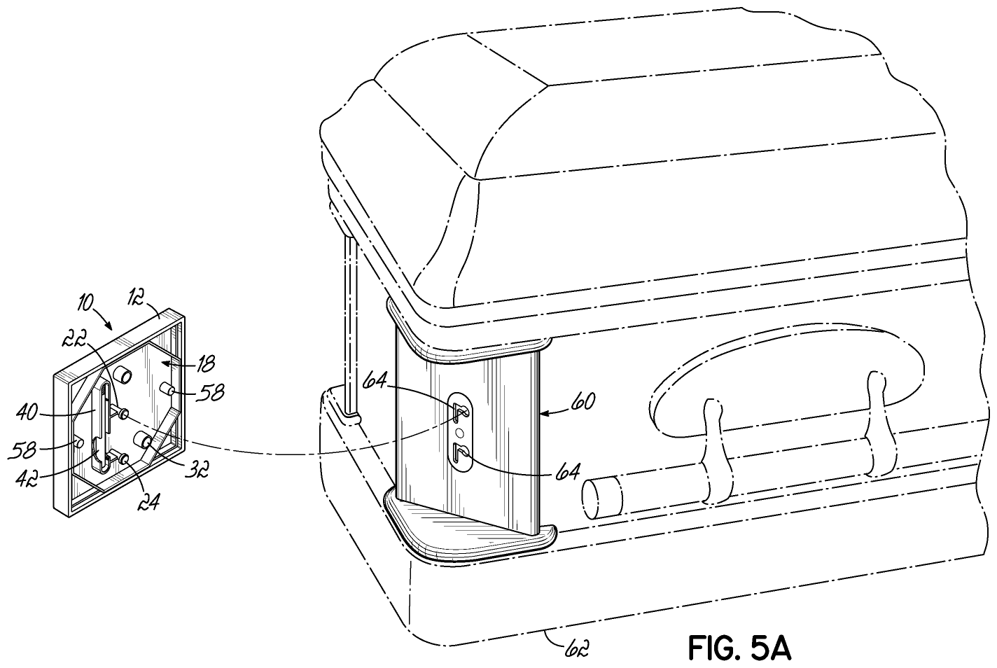

Referring now to FIGS. 2 and 5, one or two magnets 50 can be secured to the threaded posts 30 with screws 52. With the magnets 50 secured to the back plate 18, the ornament 10 can be magnetically secured to a ferrous or magnetic cap panel 54 mounted to the underside of a casket cap 56. The ornament 10 can also be magnetically secured to an urn or a display plaque having a sheet of ferrous or magnetic metal secured thereto (or fabricated of ferrous or magnetic metal). To provide some lateral stability to the ornament 10, the back plate 18 can have a pair of horizontally spaced posts 58 on a rear side thereof. The posts 58 prevent unstable tilting of the ornament 10 about a generally vertical axis when mounted to the cap panel 54.

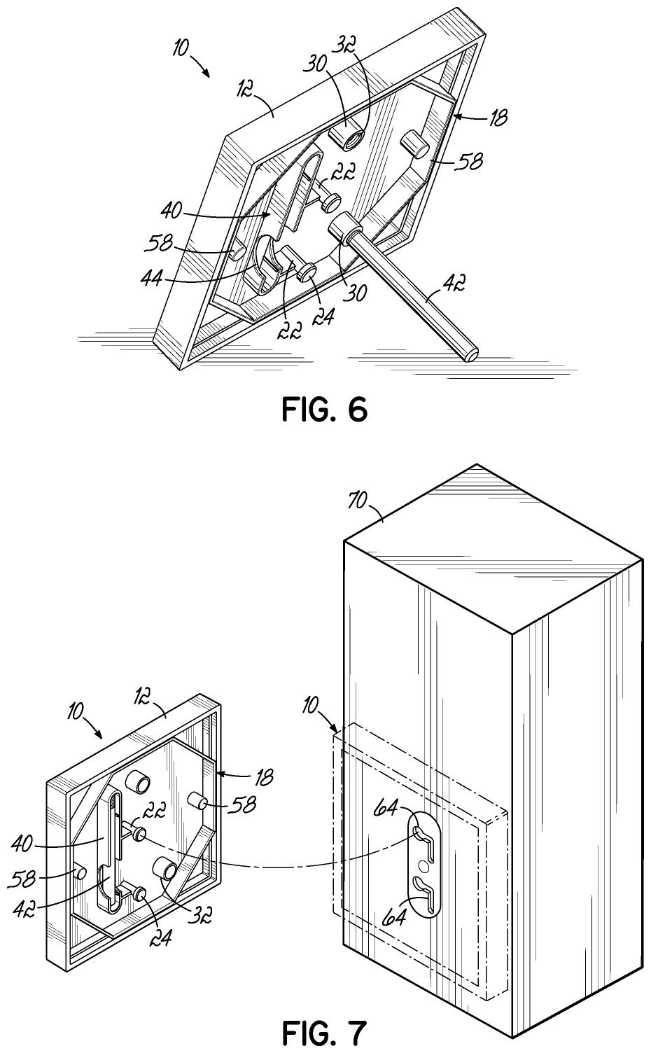

Referring now to FIGS. 5A, 5B, and 7, the posts 22 with heads 24 thereon permit the ornament 10 to be mounted to a corner 60 of a casket shell 62. Corner 60 has a pair of vertically spaced L-shaped keyhole grooves 64, which accept the heads 24 of the posts 22 to secure the ornament 10 to the corner 60.

Similarly, and referring now to FIG. 7, the posts 22 with heads 24 thereon permit the ornament 10 to be mounted to a cremation urn 70 similarly equipped with a pair of vertically spaced L-shaped keyhole grooves 64, which accept the heads 24 of the posts 22 to secure the ornament 10 to the urn 70. The ornament 10 can also be mounted to a display plaque similarly equipped with the pair of vertically spaced L-shaped keyhole grooves.

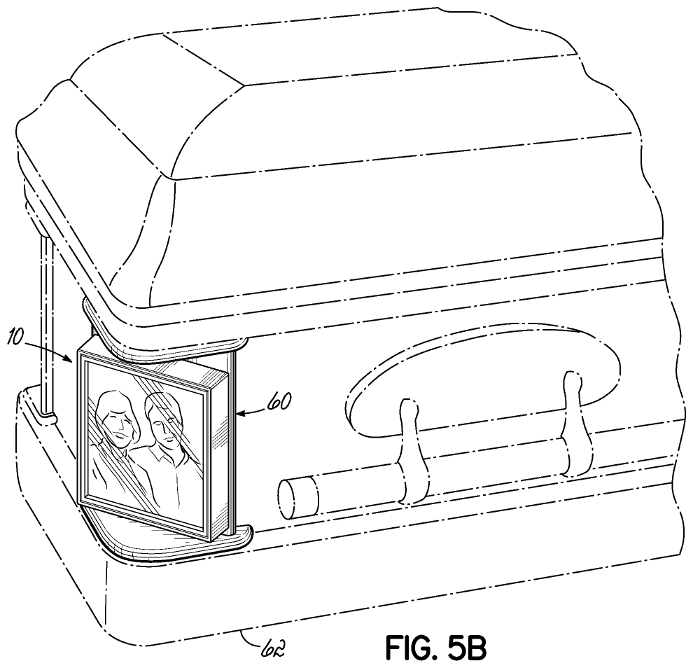

Referring now to FIG. 6, the ornament 10 can be displayed on a horizontal surface by removing the kick stand 42 from the cradle 40, and threading the threaded end 48 of the kick stand 42 into the lowermost threaded post 30. The ornament 10 is thus supported on a lower horizontal edge of the frame 12 and the free end of the kick stand 42, angling the ornament 10 at a convenient angle for viewing.

The various embodiments of the invention shown and described are merely for illustrative purposes only, as the drawings and the description are not intended to restrict or limit in any way the scope of the claims. Those skilled in the art will appreciate various changes, modifications, and improvements which can be made to the invention without departing from the spirit or scope thereof. The invention in its broader aspects is therefore not limited to the specific details and representative apparatus and methods shown and described. Departures may therefore be made from such details without departing from the spirit or scope of the general inventive concept. The invention resides in each individual feature described herein, alone, and in all combinations of any and all of those features. Accordingly, the scope of the invention shall be limited only by the following claims and their equivalents.

What is claimed is:

1. A keepsake comprising:
a picture frame,
a pair of vertically spaced posts on a rear side of said picture frame, each said post having a head thereon,
a pair vertically spaced threaded holes on said rear side of said picture frame, each of said threaded holes adapted to receive a screw to secure a magnet to said rear side of said picture frame,
a cradle on said rear side of said picture frame, and
a kickstand removably secured in said cradle, said kickstand having a threaded end that threads into a lowermost one of said threaded holes,
whereby said picture frame is adapted to be secured to a casket shell corner having a pair of vertically spaced keyhole grooves that cooperate with said vertically spaced posts with said heads thereon,
whereby said picture frame is adapted to be secured to a ferrous metallic cap panel of a casket lid which cooperates with the magnets, and
whereby said picture frame is adapted to be displayed on a horizontal surface once said kickstand is threaded into said lowermost one of said threaded holes.

2. A casket comprising:
a casket shell having four corners, each said corner having a pair of vertically spaced keyhole grooves therein,
a casket lid closeable on said casket shell, said casket lid having a ferrous metallic cap panel installed therein, and
a keepsake comprising:
a picture frame,
a pair of vertically spaced posts on a rear side of said picture frame, each said post having a head thereon,
a pair vertically spaced threaded holes on said rear side of said picture frame, a pair of magnets, and a pair of screws, each of said threaded holes adapted to receive one of said screws to secure one of said magnets to said rear side of said picture frame,
a cradle on said rear side of said picture frame, and
a kickstand removably secured in said cradle, said kickstand having a threaded end that threads into a lowermost one of said threaded holes,
whereby said picture frame is selectably 1) securable to said casket shell corner via said pair of vertically spaced posts with said heads thereon cooperating with said pair of vertically spaced keyhole grooves, 2) securable to said casket lid ferrous metallic cap panel via said magnets cooperating with said ferrous metallic cap panel, and 3) displayable on a horizontal surface once said kickstand is threaded into said lowermost one of said threaded holes.

3. A keepsake comprising:
a picture frame,
a pair of vertically spaced posts on a rear side of said picture frame, each said post having a head thereon,
a pair of vertically spaced threaded holes on said rear side of said picture frame, a pair of magnets, and a pair of screws, each of said threaded holes adapted to receive one of said screws to secure one of said magnets to said rear side of said picture frame,
a cradle on said rear side of said picture frame, and
a kickstand removably secured in said cradle, said kickstand having a threaded end that threads into a lowermost one of said threaded holes,
whereby said picture frame is selectably 1) securable to a casket shell corner, an urn, or a display plaque having a pair of vertically spaced keyhole grooves via said pair of vertically spaced posts with said heads, 2) securable to a casket lid, an urn, or a display plaque having a ferrous metallic sheet via said magnets, and 3) displayable on a horizontal surface via said kickstand.
